(19) United States
(12) Patent Application Publication
(10) Pub. No.: US 2005/0084229 A1
(43) Pub. Date: Apr. 21, 2005

(54) Light insertion and dispersion system

(76) Inventors: Victor Babbitt, Berthoud, CO (US); Neil L. McClure, Longmont, CO (US)

Correspondence Address: LATHROP & GAGE LC, 4845 PEARL EAST CIRCLE, SUITE 300, BOULDER, CO, 80301, US

(21) Appl. No.: 10/967,543

(22) Filed: Oct. 18, 2004

Related U.S. Application Data
(60) Provisional application No. 60/512,790, filed on Oct. 20, 2003.

(51) Int. Cl. G02B 6/20

(52) U.S. Cl. 385/146; 385/125

(57) ABSTRACT

A light source injects light into a translucent light guide, particularly using high-power LEDs. A core to the light guide contains a homogenous mixture of fluid and a light dispersing agent to effect scattering. Scattered light passes though the light guide and may be used for illumination. A high power LED is provided with a reflector and heat sink to disperse waste heat, increasing the efficiency and life of the LED.

### RELATED APPLICATIONS

This application claims benefit of priority to provisional application serial No. 60/512790 filed Oct. 18, 2003, which is hereby incorporated by reference.

### BACKGROUND

1. Field of the Invention

The present invention relates generally to method and apparatus for transferring or injecting light into light guides, and to heat sinking of light sources that are used to transfer or inject light into light guides, which may be arbitrarily into shaped volumes to provide light emitting elements, generally in the manner of neon signage and fluorescent bulbs. In addition, as to some embodiments, the lighting can change the color of the emitted spectrum, such as the spectrum encompassing “white” light of a specific spectrum for ordinary indoor/outdoor illumination.

2. Discussion of the Related Art

Neon lights provide bright, intensely colored lighting that is used for a large variety of signage applications, such as lighted building trim or accents, commercial signs, decorative art, and other uses. Conventional neon technology is capable of producing an emission spectrum in a narrow color spectrum. This capability provides, for example, lighted signs with bright red or blue designs without requiring special filtering of the source of the light, as would be required with incandescent lighting.

However, neon lighting technology demands extremely high operational voltages, in the range of 3,000-15,000 volts. Neon devices trap special gases within a light-transmissive but nonporous material, and the material of choice is glass. Therefore, being comprised of bent glass tubing, neon lights are extremely fragile, and the high-voltage power supplies used in neon lighting have limited service life. Neon lighting does not, in general, permit the intensity of the output light to vary, i.e., the light is not dimmable. These factors limit neon lighting markets in many ways. Building codes and safety concerns prohibit neon lighting from being used in applications such as lighted trim that frames a window and lighting for swimming pools. Neon devices may emit significant electromagnetic interference (EMI) from the hi-voltage neon power supply, and this is problematic in many environments of use.

Neon lights are typically made of blown glass, and the shape configuration cannot be altered once the shape has been formed into the final product. Neon lighting is non-portable, and only a single color may be displayed in any one neon tube. Therefore applications for temporary or portable signage, lighting or lighted trim are not well served by neon technology. Neon technology cannot support any application where changing color is desired within a tube, plane, or other volume.

Fluorescent lighting also suffers similar limitations since fluorescent lighting requires high voltages to operate and the bulbs are extremely fragile. Fluorescent lights have a limited service lifetime, which necessitates changing bulbs with some frequency. Fluorescent lighting technology suffers from additional limitations: Fluorescent lighting systems that can vary the output intensity are unrealistically expensive. Fluorescent lighting has a single or fixed spectral output in any one tube, and many desirable colors or spectral distributions are not producible by fluorescent technology. The output spectrum of a fluorescent light is limited to the excitation energy of the gas within the tube, and there is no combination of gas that optimizes the output spectrum for the human eye. This causes considerable eye strain and reduced clarity when used to illuminated interior spaces such as office environments. Additionally, fluorescent lights operate typically at 60 hertz AC power, causing flicker and increasing the induced eye strain.

Therefore, while both neon and fluorescent lighting enjoy large markets, both technologies suffer from many deficiencies which include, but are not limited to, cost, safety, lifetime, lack of flexibility and alterability, lack of ability to alter color, lack of ability to dim or change intensity, portability, and sub-optimized output spectrums.

Some solutions to the deficiencies of neon and fluorescent lighting have included lighting from glass, plastic or liquid filled light guides that use the principal of total internal reflection (TIR) to reflect light down the core of a potentially curved, bent tube or fiber with minimal losses. This type of lighting is commonly referred to as “fiber optic lighting”, and is well known in the art. All of these solutions have the common aspect that each fiber or guide has a ‘core’, an optically transparent medium, whether glass, acrylic plastics or various clear liquids, which has the property of having a relatively high index of refraction. The core is surrounded by a “cladding”, which is a generally transparent material of low index of refraction, and is very often a perfluoropolymer such as certain types of transparent Teflon. The cladding is then typically surrounded by a “sheath”, which has no particular optical properties, but provides various mechanical support or environmental protection. The well known property of TIR allows light entering the end of a light guide at a relatively low angle to the core/cladding interface to be reflected with almost no loss at this interface. Therefore, this allows a large percentage of light entering the light guide to transverse the length of the light guide and exit it, even though the light guide may flex or bend around corners.

The principle of TIR is well-known, and operates on the principle of refraction. Refraction is the process by which light enters a transparent medium and its direction of travel is altered. In general, when two materials have an index of refraction that differ from one another, a ray of light traveling through the interface does not continue on a straight line from one material to the other. The pathway on which the light travels is bent at angle. The magnitude and direction of this angle depends on three things: (1) the angle of incidence of the ray with respect to the interface, (2) the refractive index of the medium that the ray was initially traveling through, and (3) the refractive index of the medium following the interface.

The TIR phenomenon is governed by the principle of Snell's Law, as shown in Equation (1):
nᵢ*sin Θᵢ=nᵣ*sin Θᵣ (1)
where Θᵢ is the angle of incidence taken with respect to a normal (perpendicular) line drawn to the interface; Θᵣ is the angle of refraction taken with respect to the normal; nᵢ is the index of refraction of the incident medium, and nᵣ is the index of refraction of the refractive medium. The indices of refraction for a variety of materials are well known and may be found, for example, in published literature such as the CRC Handbook of Chemistry and Physics from The Chemical Rubber Company of Boca Raton, Fla., Ann Arbor Mich., and Boston, Mass.

In effect what happens in TIR is that the light is reflected at the incident angle. This is the basis of optical fiber waveguides. By way of example, the reflectance of most mirrors is around 95 to 99%. This means that at each reflection around 1 to 5% of the power is lost with each reflectance. If you have a mirror waveguide that is even 20 meters long, this adds up to a lot of reflections and hence a lot of power loss. The advantage of TIR is that no power is lost in the reflection, hence the term “total internal reflection,” although some transmissive losses may occur in the core. In waveguides the core has, for example, a refractive index of around 1.55 and the cladding around 1.45 in glass-Teflon materials. By application of Snell's law, this gives a critical angle of 69 degrees, i.e., as long as the light hits the waveguide wall at more than 69 degrees to the perpendicular then total internal reflection will occur. This may be expressed as:
sin Θ_{C}=nᵣ/nᵢ (2)
where Θ_{C} is the critical angle and the remaining terms are defined above. TIR only occurs when light moves from a material with a higher refractive index relative to the material it is entering.

When using light guides to produce neon-like effects, the prior art is limited to focusing a light source onto the end of these light guides, and then dispersing or scattering the light out the side of the light guide through special coatings in the cladding or by cutting or deforming the cladding in some way, or by bending the tubing at angle that exceed the limits of TIR reflectance.

Glass fiber optics are substantially rigid and the individual fibers must be made very fine to impart some flexibility. Light guides using glass fiber optics are generally bundled into thousands of very fine glass fibers constrained by an outer sheath. Acrylic or plastic fiber optics are often bundled as well, since these plastic fibers tend to be stiff or non-flexible at sizes over a few millimeters. For neon-like applications, single large diameter plastic fiber light guides may be used, for example, up to 12 mm in diameter, although such large plastic fibers are substantially rigid. These sorts of glass or plastic light guides are also used for transporting light of specific color or spectrum for lighting of objects, such as downlighting used to highlight art in museums or store display shelves and allowing objects to be lit by a certain color of light without the heat or damaging UV radiated or emitted by typical incandescent lights.

Both glass and plastic light guides suffer significant deficiencies if they are to be used in applications to replace neon technology. Light guides of this type are expensive and rigid at the diameters required for neon-like effects. Both glass and fiber light guides suffer from the high cost of the light source required to illuminate the light guides. This light source must provide sufficient light, filter this light to produce the appropriate spectrum, and reflect or otherwise concentrate this light onto the end of the light guide.

These light sources are cumbersome to use and have a low efficiency. Every reflection within the focusing or concentrating illuminator mean loss of light by absorption or scattering. In addition, every interface that light must transmit through imposes a reflective or absorptive loss. This is particularly evident as the light passes into the light guide itself, where the light guide core medium has a much higher refractive index than air that causes reflection at the interface. Absorptive and reflective losses also occur when light is sent through any color filter. In addition, for light guides that are composed of multiple fiber optic fibers in a bundle, light is lost at the interstices between these fibers when light impinges on the cladding instead of the core. All of these losses not only reduce the amount of transmitted light but result in a buildup of heat within the light source system, and at the front end of the light guide, which must be eliminated from the system for safety reasons or to reduce degradation of the light guide materials.

One of the remaining challenges for this type of lighting is to create light sources that can be embedded within the core fluid to provide enough optical power to meet neon-like and other lighting applications. Advances in high-powered light emitting diode (LED) technology have the potential to be an excellent source of colored and white light for sources of supplying energy to light guides of a variety of configurations. However, these high-power LEDs generally have a wide dispersion angle (Lambertian dispersion), which makes them very inefficient to couple to most light guides using TIR, where the TIR effect requires some collimation of the light source. In addition, these high-power LEDs produce a significant amount of waste heat. Unless this waste heat is removed from the device, the temperature at the LED junction will quickly raise to the point where production of light is very inefficient or the LED device fails.

### SUMMARY

The present invention overcomes the problems outlined above and advances the art by introducing a scattering agent into a core material that is contained in an optical waveguide. The scattering of transmitted light that results from inclusion of this scattering agent occurs, in part, at angles above the critical angle of TIR. By “above” the critical angle it is meant that the angle of incident light on the optical pathway impinging upon the light guide enters the range of the critical angle, and so may pass through the translucent light guide. Conversely, “below” the critical angle means that the angle of incident light on the optical pathway impinging upon the light guide does not enter the range of the critical angle, and so does not pass through the translucent light guide. Additionally, a system is provided for the removal of waste heat from LEDs, which advantageously increases the life and efficiency of LED light sources. Accordingly, the structures described may be used to replace neon or fluorescent lighting at intensities that are as great or even greater than present neon lighting systems.

In one embodiment, a light guide system operates on the principle of TIR between a core and a cladding along an optical pathway. The cladding is translucent, which means that appreciable light can pass through the cladding. A light dispersing agent is distributed in the core to provide a substantially even disruption of TIR along the optical pathway, such that a portion of disrupted light passes through the cladding where the portion of disrupted light impinges upon the cladding at an angle above the critical angle for TIR. The core may be a liquid, such as a liquid having a majority component of mineral oil. In this case, the light dispersing agent may be, for example, titanium dioxide, alumina, or a combination thereof.

The system may be adapted, constructed and arranged to provide lighting by analogy to any lighting structure that is known in the prior art. By way of example, the system may be constructed and arranged as a channel letter in the manner of prior art neon signs or, more generally, as a flexible liquid filled tube. Thus, may be made safety lights, automotive lights, recreational lights, boat lights, swimming pool lights, and hot tub lights. The system may be constructed and arranged as a solar powered outdoor trim light, interior baseboard light, building trim light, interior mood light, home holiday light, or a personal sign. Other embodiments suitably include a fishing lure, a necklace, a bangles, clothing trim, a clothing accent, and a toy. There may also be provided a carnival ride light, a lighted bike helmet, or a lighted bike frame. Other uses extend to Christmas lights, and a boat mast light.

In another embodiment, the light guide system includes an translucent optical waveguide and a core where the translucent optical waveguide and the core have different indices of refraction permitting optical interaction by TIR. An optical dispersing agent is mixed with the core to disperse light from the light guide by disruption of TIR.

In a method of operation to provide illumination, the method begins by activating a light source to emit light along an optical pathway that is defined by a core interacting with a translucent light guide in a mode of total internal reflectance (TIR). There is consequent disruption of light on the optical pathway by incidence upon a light-dispersing agent to cause disrupted light to exit the translucent waveguide where the disrupted light impinges upon the light guide at an angle above a critical TIR angle.

A method of making the light guide system may begin by coating a translucent tubular structure with a light guide-forming material, such as a perfluorcarbon or another material having a suitable index of refraction for this purpose. There is mixing of a light dispersing agent to substantial homogeneity with a liquid core material to form a mixture, where the mixture has an average index of reflection that is higher than that of the light-guide forming material. The translucent tubular structure is filed with the mixture to form a core. A light source is placed in optical communication with the core for emission of light into the core at a suitable angle for TIR to occur between the core and the light guide-forming material. The core is sealed within the translucent tubular structure.

A particularly preferred light source for these purposes is an LED assembly that includes an LED die supported by a substrate. Electrical contacts are placed to provide power for activation of the LED die to emit light. A reflector is bonded to the substrate and operable to direct light from the LED die along an optical pathway when the LED die is activated for emission of the light. The reflector may have a frustoconical shape. A heat sink may be in thermal contact with the substrate to effect cooling. The light source may be embedded into the core such that it projects light forward onto an optical pathway. Here “embedded” means that the optical source is at least partially immersed in the core such that the emitter, e.g., an LED or a bulb, is in direct contact with and covered by the core. Since this direct manner of light transmission in a cycle of light transmission and non-transmission may produce expansion and contraction of the core, the resultant pressure swings may be compensated by use of a gas expansion chamber located inside the light guide but outside the optical pathway.

A single LED light source, or preferably a plurality of high-power LEDs, may be used to illuminate a liquid-filled light guide. An optical dispersing agent may be distributed throughout the core and/or the cladding to scatter light along the length of the light guide to produce ‘neon-like’ effects. While a liquid filled light guide may typically be tubular in design, the present invention is not limited to cylindrical pipes or other geometrical shapes. Flat panels that sandwich core liquids between them, or that sandwich any volume where there is a desire for the volume to be intensely illuminated with the light sources described herein.

### BRIEF DESCRIPTION OF THE DRAWINGS

FIG. 1 is a front view of a typical high power LED without a transparent spherical cap;

FIG. 2 is an midsectional view of the high power LED;

FIG. 3 is a midsectional view of a high power LED with a collimating cone attached that also provides heat sinking for the LED.;

FIG. 4 is a midsectional view of a liquid filled light guide with details of an LED based illuminator assembly;

FIG. 5 is a top view of a complex channel letter lit with embedded LED lighting;

FIG. 6 is a sectional detail view of a portion of the channel letter in FIG. 5 showing details of reflective and TIR features of this type of channel letter;

FIG. 7 is an axial midsectional view of an elongated liquid-filled light guide used to produce ‘neon-like’ light, with illuminator assemblies at both ends of light guide;

FIG. 8 is an axial midsectional view of an elongated liquid-filled light guide used to produce ‘neon-like’ light, with illuminator assemblies at one end of light guide;

FIG. 9 is an axial midsectional view of an elongated liquid-filled light guide used to produce typical fiber optic downlighting or for end-lit applications;

FIG. 10 is a midsectional view of the end of a liquid filled light guide with details of an LED based illuminator assembly;

FIG. 11 is a midsectional view of an illuminator assembly using incandescent lighting;

FIG. 12A is includes a perspective view of a system pressure compensator in the form of a gas expansion chamber;

FIG. 12B shows the system pressure compensator in a vertical orientation;

FIG. 12C shows the system pressure compensator rotated 90° with respect to the orientation shown in FIG. 12B;

FIG. 12D shows the system pressure compensator rotated 180° with respect to the orientation shown in FIG. 12B; and

FIG. 13 is a midsectional view of a light guide end including illuminator assembly and pressure compensator;

### DETAILED DESCRIPTION

There will now be shown and described a lighting system that operates on the principles of TIR. At a selected system component, which may also be the entire system, a core is impregnated with a light redirecting agent, which causes a portion of light that is being transmitted through the core to impinge upon translucent cladding at an angle above the critical angle for TIR reflectance. Thus, light escapes the core and cladding and may be used, for example, to illuminate a room or a work area.

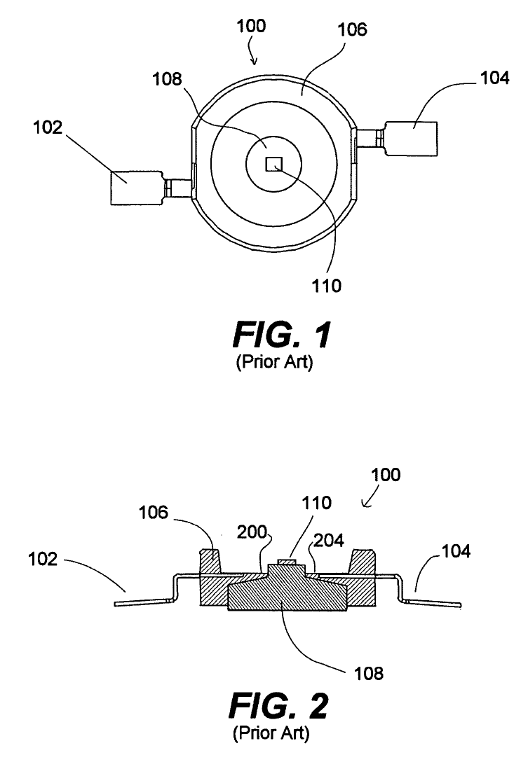

FIG. 1 is a front view of a conventional high power LED 100. For clarity, LED 100 is shown without a conventional spherical clear lens assembly that reduces dispersion. As used herein, the term “high power LED” means any LED that is suitable for illumination purposes, and this may include a plurality of LED dies. Power is applied to the high power LED 100 through contacts 102, 104. The high power LED 100 is mounted in a plastic case 106, which is typically made of an acrylic resin. Embedded into this plastic case 106 is a metal substrate 108 that provides a retaining platform for an LED die 110. The metal substrate 108 is attached to the LED die 110, for example, with a thermally conductive epoxy. During operation, the LED die 110 produces a large amount of waste heat.

Presently available commercial LEDs have a spherical clear acrylic lens that is typically placed over the LED die 110 (not shown). The lens prevents heat from escaping easily in the direction of the lens. Therefore virtually all of the heat removal must occur through the junction between the LED die 110 and the metal substrate 108. The metal substrate 108 is typically then thermally bonded to a larger heat sink assembly. Removing excess heat is sometimes necessary, for example, as the light output from LED die 110 at 20° C. may be only 20% of light output at 25° C., and the high power LED 100 may permanently fail at substantially higher temperatures.

FIG. 2 is a midsectional side view of the high power LED 100. Contacts 102, 104 extend towards the LED die and are placed in electrical contact therewith by the provision of fine gold leads 200, 204.

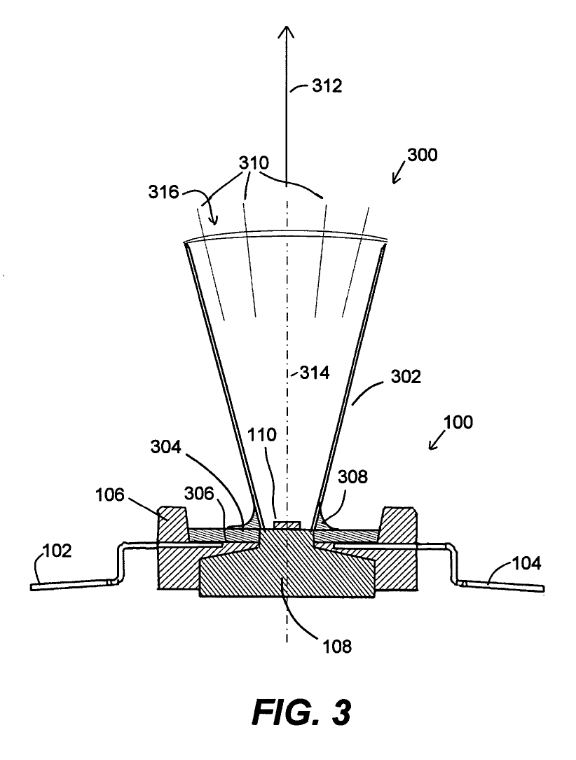

FIG. 3 shows the high power LED 100 in an assembly 300 with reflective cone 302 attached to the high power LED 100. An epoxy or other resin 304 secures the reflective cone 302 to surface 306 of the high powered LED 100. Additional epoxy may be provided to increase surface area contact, for example, as meniscus ring 308, to facilitate a heat conduction path from the metal substrate 108 to the reflective cone 302.

The reflective cone 302 collimates the light emitted from the LED die 110, preferably, so that the exit angles of light rays 310 leaving the assembly 300 do not rise above the critical angle for TIR when transmitted through a light guide (waveguide) or light volume. This is because only light that transmits generally on optical pathway 312 emitted at acceptable angles for TIR is internally reflected within the light guide or light volume. As shown, cone 302 is frustoconical, but may alternatively, for example, have a shape that is parabolic, non-imaging compound parabolic, or another shape that collimates the light to meet the TIR requirements in the environment of use. The reflective cone 302 as shown has a circular cross-section but may have any other cross-section, such as an elliptical or rectilinear cross-section.

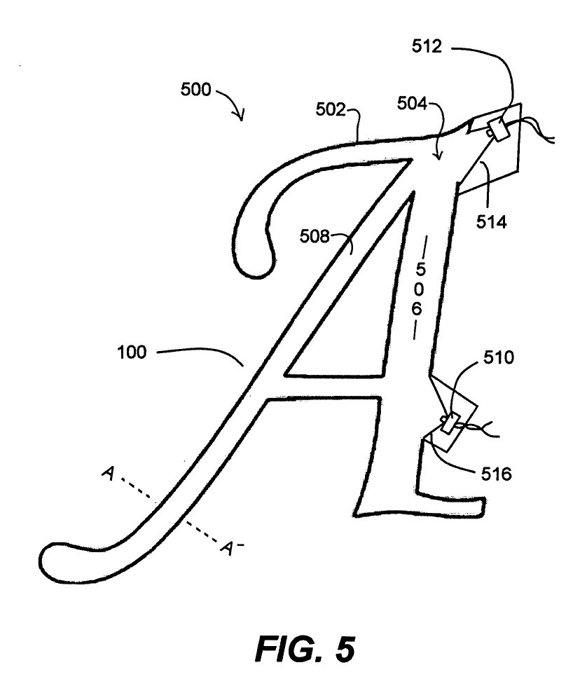

If the assembly in FIG. 3 is used to illuminate a channel letter or flat panel, which uses TIR reflective panels or mirror panels (see FIG. 5 below), then the cone 302 need only collimate the light in a direction commensurate with the requirements of TIR. This may, for example, place pathway 312 off-axis with respect the axis of symmetry 314 of the high powered LED 100. For example, in the channel letter in FIG. 5, TIR is used to internally reflect light in the vertical or z direction, but not in the horizontal plane or x,y directions. Therefore the reflective cone need only collimate the light leaving the LED assembly in the vertical or z direction.

This reflective cone 302 is an improvement on using conventional refractive lens or assemblies. A refractive lens assembly that is placed in direct contact with a translucent fluid works much less efficiently, if at all. This is because a difference in refraction between the refractive index in the lensing material and in the fluid is small. This reflective cone 302 may be made of any material that is reflective for the wavelength desired. This includes plastic coated reflectors, metal coated reflectors, straight metal reflectors (silver, aluminum), and thin film mirrors that efficiently reflects light of certain wavelengths.

Elimination of the conventional lens from the high power LED 100 allows fluid to come into direct contact with the LED die 10 through opening 316, which provides for direct transfer of waste heat into the core fluid. This heat transfer increases the power conversion efficiency and service life of the high power LED 100. This method of transferring heat directly to the fluid surrounding the LED die 14 has numerous applications within light guides and light volumes and for any other application where the efficient heat sinking of high power LEDs is desired.

By way of example, a reflective cone 302, is constructed of a heat conductive material, such as aluminum, copper or silver, that provides direct heat sinking of waste heat that the high power LED produces, when the reflective cone 302 is thermally bonded, via thermally conductive epoxy 304, 308 to the metal substrate 108.

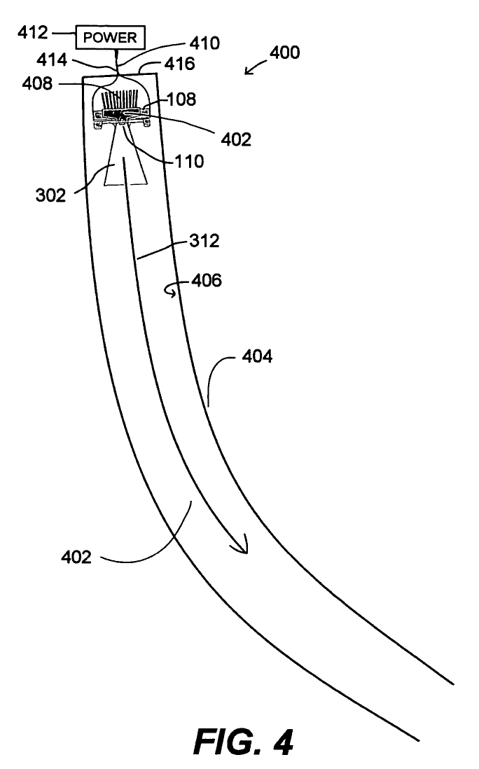

FIG. 4 shows a typical liquid filled light guide 400 that includes a high power LED assembly 100 in direct contact with a translucent or light transmissive core fluid 402 A tubular light guide wall 404 is itself made of or has in inner surface lining 406 that is made of a material having a lower index of refraction than the core fluid 402. The tubular light guide wall 404 or inner surface lining 406 may, for example, be made of a perfluoropolymer, such as Teflon that having a low index of refraction to assist TIR by optical interaction with the core fluid 402. The high powered LED 100 is in thermal contact with a heat sink 408 that is thermally bonded to the metal substrate 108. Wires 410 provide driving current for the high powered LED 100 and are connected to power source 412 for this purpose. The power source 412 may include a function or pattern generator for actuating the high power LED 100 in a predetermined way or according to a user-selectable pattern.

The light guide 400 allows the efficient transfer of light on optical pathway 302 from the high power LED 100 into the core fluid 402. Reflective cone 302 collimates the majority of light that is emitted by high powered LED 100 generally onto pathway 312, which propagates generally as shown by TIR interaction with the light guide wall 404 and/or inner surface lining 406. Transfer of waste heat occurs from the high power LED directly into the core fluid 402, for example, through the heat sink 408, through the thermally bound reflective cone 302, and through direct contact of the core fluid 402 with the LED die 110.

As shown in FIG. 4, wires 410 are twisted to pass through a common opening 414 in rear wall 416 of the tubular light guide wall 404. An alternate configuration (not shown) repositions the heat sink 408, such that part of the heat sink 408 is in contact with the core fluid 402 and the other-side of the heat sink 408 is in contact with the external environment rearward of rear wall 412. In this alternative configuration, for example, the heat sink 408 may also form a plug for the tube. As shown in FIG. 4, there is a single high power LED, but in a less preferred sense this may be replaced by any other light source including incandescent bulbs, fluorescent lighting, fiber optic injection of light, an array that contains a plurality of LEDs or other light sources, a laser, a laser emitting diode, or another light source.

The core fluid 402 is preferably a liquid suspension or mixture that is translucent for the passage of light on pathway 312. As shown in FIG. 4, the configuration does not result in significant loss of light through the tubular light guide 404 because TIR prevents this from happening. On the other hand, it is frequently desirable to encourage this loss of light by introducing a light-redirecting agent into the core fluid 404. By way of example, where the light dispersive agent acts by scattering, the light-dispersive agent is preferably a titanium dioxide or alumina suspension in a core fluid 404 that is based upon primarily mineral oil Alternatively, a luminesencent chemical may also be added to the core fluid 404 to act as a light dispersive agent. Fluorescence and phosphorescence are luminescence phenomena that occur following stimulation or excitation of a material by photons or electrons. By way of example, J. N. Demas, and B. A. DeGraff disclose such chemicals in “Design and Application of Highly Luminescent Transition Metal Complexes,” Anal. Chem. vol. 63 n17 829-37,1991. Classes of suitable chemical include mettalo-porphyrins and organo-ruthenium complexes.

FIG. 5 shows a complex stylized channel letter 500 in the form of an “A.” The channel letter 500 is constructed generally in a shape that might, for example, also be imparted to neon tubing. Channel letters are letters, usually from 15 inches to 50 inches in size, wherein the letter is formed of a metal or plastic case 502. The case 502 has a front opening 504 that may be left open or sealed with a transparent or translucent cover 506. This channel letter is then lit from within an interior volume 508. One of the deficiencies of using neon to light channel letters is that complex and scriptive letters are difficult to light evenly if at all, as the neon tubing cannot be easily bent down narrow passages.

The interior volume 508 is filled with a core fluid, which contains a light-dispersive agent. The top surface 506 of the channel letter 500 enclosing the opening 504 to seal interior volume 508 is transparent, and the inner surfaces of case 502 defining volume 508 have, generally, both mirror reflective surfaces and surfaces that support TIR interaction between these surfaces and the core fluid within the interior volume 508. The top surface is similarly coated to act as a light guide, except the top surface is transparent or translucent.

In this complex channel letter 500, there are a plurality of LED light assemblies 510, 512, which may be the high power LED assembly 400 that is shown in FIG. 4. As shown in FIG. 5, reflectors 514, 516 replace cone 302 (shown in FIG. 4) and are constructed and arranged for suitable direction of light as needed by the structure of case 502. The LED light assemblies 510, 512 and reflectors 514, 516 are covered by and indirect contact with core fluid filling volume 508. Light leaving the LED light assemblies 120 does not exit the front surface immediately, being totally reflected via TIR within the channel, i.e., within volume 508. Light that impinges on a vertical surface, such as the sides of the channel, is reflected back within the channel. A light dispersing agent in the core fluid scatters light to disrupt the TIR effect. Light that is scattered toward the back or sides of the channel letter is reflected by the mirror surfaces until all light eventually exits via the front surface 506, except for a minor amount of light that is absorbed by the mirrored surfaces and impurities within the core fluid.

This method of lighting a channel letter permits uniform lighting of cursive, scriptive, and other complex forms of channel structures.

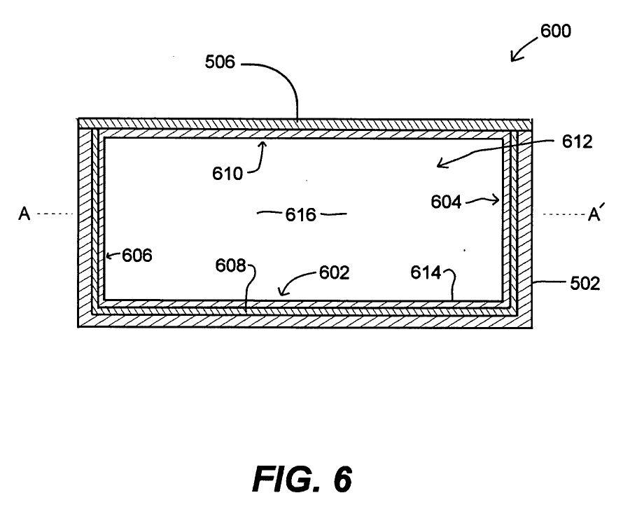

FIG. 6 shows a cross section of the channel letter 500 taken along line A to A′ of FIG. 5. The resulting channel section 600 is composed of a metal or plastic case 502, which of itself need have no particular optical property. The front surface 506 is composed of a transparent material such as glass or acrylic. The bottom of the channel section 600 and the sides 604, 606 are coated with a reflective material 608. The bottom 608 and the sides 604, 606, as well as the top 610 of channel 612 (all surfaces) are coated with a TIR coating 614 that supports TIR in combination with the core fluid 616. The TIR coating 614 may be a perfluorpolymer. This TIR coating 614 at sides 604, 606 is preferred, but optional. Again, the core fluid 616 may be mineral oil that contains a homogenously distributed light dispersion agent. This combination of materials allows even distribution of the light through the channel and provides that virtually all light exits the top surface only.

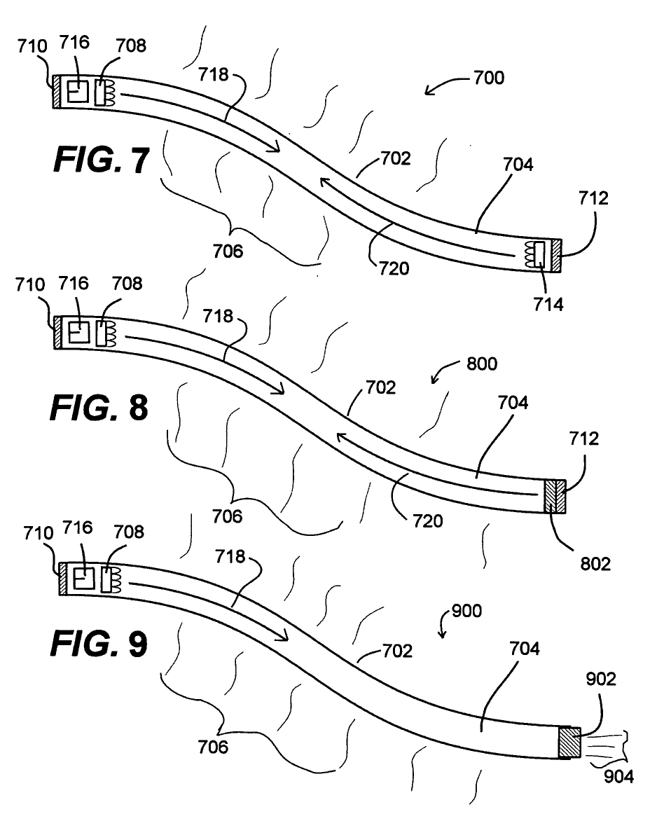

FIG. 7 shows a ‘neon-like’ lighting system, light guide 700, according to one embodiment. The light guide 700 is composed of a flexible translucent tubular pipe 702 that provides TIR interaction with a liquid core 704 This may be achieved by pipe 702 being composed of or lined with perfluoropolymers of low refractive index, such as fluorinated ethylene polymer (FEP), polytetrafluoroethylene PTFE, perfluoroalkoxy (PFA), Cytop, Teflon AF-1600, Teflon AF-2400, and 3M Flourad 722, 724 and 725. Additionally, if used with the liquid core composition disclosed below that includes sub-optical liquid colloidal suspension; the pipe 702 may be constructed of any transparent material, such as transparent polyethylene, that will produce TIR with the liquid core sufficient to capture the illumination within the pipe 702. Liquid core 704 is either the scattering liquid colloidal suspension composition described herein, or a composition that includes the sub-optical liquid colloidal suspension also described herein. This liquid core 704 refracts light radially out the sides of the tube 702, and so produce a ‘neon-like’ glow 706. An illuminator assembly 708 is covered by the liquid core 704 and affixed in a position within the tubular pipe 702.

The illuminator assembly 708 may be a plurality of high-intensity LEDs. These LEDs are preferentially designed to produce light in a narrow beam, such that the beam angle is low enough that substantially all light leaving the LEDs will remain trapped in the pipe 702 (a light guide) by TIR. Wires or a battery for power and control of the LEDs are also present, but are not shown for simplicity. The pipe 702 is sealed at ends 710 712, which may be permanent or removable seals. In FIG. 7, another illuminator assembly 714 is shown such that the pipe 702 is illuminated from both ends for increased intensity of glow 706. Behind illuminator assembly 708 is an gas-filled expansion chamber, 716 which compensates for the internal pressure changes that can lead to light guide leakage or bubble formation, especially by the heating and cooling of the liquid core 704. FIG. 1 is a neon-like light guide, having a light color that is defined by selection of the LEDs in illuminator assemblies 708, 714. Thus, there are two optical pathways, 718, 720 for TIR through the liquid core 704. The color of glow 706 may be selectively adjusted by activation of selected LEDs in illuminator assemblies 708, 714 under the control of power electronics (not shown). It is possible to activate LEDS in the illuminator assemblies 708, 714 to emit in different spectra that combine in glow 706, for example, to combine red and yellow emissions as an orange glow 706.

FIG. 8 shows a light guide 800 that is the same as light guide 700 to the extent of like numbering for identical components. In place of illuminator assembly 714 is provided a mirror 802, which is situated proximate end 712. The mirror 802 reflects light that reaches end 712, which is remote from illuminator assembly 708. The reflected light on pathway 720 reverses direction from pathway 718 and travels back through the liquid core 704 for further dispersion into glow 706. The liquid core 704 is essentially the same as liquid core 704 in FIG. 7, but may differ, for example, in the formulation by the ratio of scattering particles to liquid core, which is selected to create a glow 706 or visible illumination that is more evenly distributed along the length of pipe 702.

The particles that produce this scattering are preferably “suboptical” in the sense that in combination they increase the total refractive index of the core but individually are of insufficient size to provide significant refraction. This occurs for example, in a colloidal suspension when the particles have an average diameter less than one half wavelength of the applied spectrum. Particles of from 5 nm to 100 nm are preferred for most applications, with particles of 15 nm to 40 nm in average diameter being particularly preferred.

FIG. 9 shows a light guide 900 that is the same as light guide 700 to the extent of like numbering for identical components. In FIG. 9, end 712 has been replaced by a lens cap seal 902. The lens cap seal is, for example, a conventional lens for distribution of fiber optic end lighting. Generally, the lens cap seal 904 radiates light 904. In this embodiment, the majority of the light emitted onto pathway 718 does not exit the light guide sides as glow 706, but exits out the lens cap seal 902. The lens cap seal 902 has an additional function-that of a seal or plug for pipe 702. The liquid core 704 is similar to liquid core 704 in FIG. 1, but does not necessarily contain a liquid suspension or mixture of a light dispersing agent.

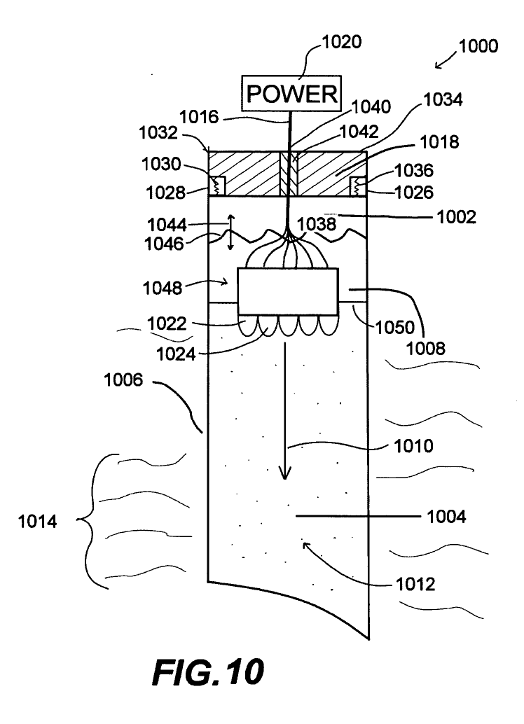

FIG. 10 shows an end structure 1000 that contains a bubble expansion chamber 1002 which may be used to compensate for pressure changes in a liquid core 1004. A translucent tubular light guide 1006 interacts with the liquid core 1004 to place emissions from LED illuminator assembly 1008 in TIR mode on pathway 1010 through the liquid core 1004. Light on pathway 1010 encounters particles 1012, which are suspended in the liquid core 1004, and this results in a Mie scattering phenomenon that disperses a portion of light on pathway 1010 resulting in TIR incidence of light upon the light guide 1006 and consequent emissions as glow 1014 traveling through the walls of light guide 1006.

The LED illuminator assembly 1008 is immersed internally within the liquid core 1004. A cable bundle 1016 passes through end cap 1018 to connect the illuminator assembly with power electronics 1020. The power electronics 1020 are capable of selectively activating individual LEDs 1022, 1024 for the emission of light on pathway 1010.

The end cap 1018 may be removed to permit maintenance access. An annular ring 1026 presents a smooth radial outboard surface 1028 that is adhesively bonded or clamped (clamp not shown) to the light guide 1006. The annular ring 1026 provides radially inboard threads 1030. A plug 1032 includes a winged cap 1034 that narrows in radius to radially outboard threads 1036 engaging radially inboard threads 1030. An O-ring seal (not shown) prevents the escape of gas and/or liquid from within the light guide 1006. A central aperture 1040 permits the passage of cable bundle 1016 through the end cap 1018 and is sealed with a resin 1042 to prevent the escape of gas and/or liquid from within the light guide 1006.

In FIG. 10, the end cap assembly is in a vertically orientation, such that the gas expansion chamber 1002 remains above the LED illuminator assembly 1008. Bubble formation in liquid-filled light guides may be a serious problem because these bubbles interfere with the transmission of light in TIR mode. Bubbles may form, for example, because the thermal coefficient of expansion for the liquid core 1004 is usually greater than that of the cladding or sheath material such as light guide 1006 surrounding the core. As the assembly is cooled, the liquid core 1004 contracts more readily than does the light guide 1006, and this contraction may create appreciable negative pressure in the liquid core 1004. Absent the gas expansion chamber 1002, this negative pressure may, for example, break down the O-ring seal 1038 or otherwise suck outside air into the light guide 1006 through liquid impermeable but gas permeable micropores in the light guide 1006.

As shown in FIG. 10, where the LED illuminator assembly 1008 is immersed in the liquid core 1004, bubbles or gas in the gas expansion chamber 1002 are of no consequence to TIR. Since the compressibility of gas is several magnitudes greater than the compressibility of liquids, a small gas chamber 20 behind the illuminator assembly can provide an internal expansion chamber, allowing liquid to expand or contract without appreciably changing the internal pressure of the light guide. In the case of the vertically oriented light guide, as shown the end structure 1000 of FIG. 10, the gas expansion chamber 102 may be a space at the upper end of the light guide 106. The amount of gas in the expansion chamber is sized for the environment of use, such that at minimum operating temperature, the LED illuminator assembly 1008 is still immersed within the liquid core 1004, and at maximum operating temperature the internal pressure does not rise to a level that may overcome the O-ring seal or other system seals. Note that this system allows for some maintenance of the liquid core 1004 and LED illuminator assembly 1008 by opening the end cap 1018, such that the liquid core 1004 may be replaced of the volume adjusted. With this arrangement it is not actually required to seal the upper end of the light guide 1006, and end cap 1018 is optionally omitted.

Heating of the liquid core 1004 and/or external ambient pressure changes are reflected by a rise or fall 1044 in an interface 1046 between the gas expansion chamber 1002 and the liquid core 1004; however, the relative volumes of gas an liquid are such that the interface 1046 does not fall below the LED illumination assembly 1008, and especially not so low as to interfere with emissions on pathway 1010. In this manner, the gas expansion chamber 1002 prevents or mitigates bubble formation in the liquid core 1004 which, otherwise, may interfere with the desired TIR effect and result in an uneven distribution of glow 1014. A vertical orientation of the end structure 1000 positions the gas expansion chamber 1002 at an uppermost position—a result of gravity segregation between liquid and gas phases. Thus, any bubbles which may form in the liquid core 1004 eventually migrate upwards into the gas expansion chamber 1002. The gas within gas expansion chamber 1002 is preferably not reactive with the liquid core 1004 and may, for example, be nitrogen or argon when the liquid core is primarily mineral oil. Immersing the embedding LED illumination assembly 1008 within the liquid core 1004 solves many problems. It will be appreciated that an alternative external light source may be used, such as a fiber optic structure entering through aperture 1040 to inject external light. In this alternative, the use of external light is associated with losses including reflective, diffusive and absorptive losses from the fiber optic device. There is also the problem of heat removal from either an external or internal source, but the problem of heat removal is reduced in the case of the internal source shown as LED assembly 1008 immersed in the liquid core 1004. The gas expansion chamber 1002 compensates for the increased heat problem by facilitating heat transfer into the liquid core 1004 from the LED illumination assembly 1008 while compensating for the fluid pressure effects within light guide 1006.

The LEDs 1022, 1024 may include bare LED dies, for example, as shown in FIG. 1, which are open to and in direct contact with the liquid core 1004. The LEDs 1022, 1024 may be covered with optical components, such as lenses or reflective cones (not shown) to shape the light beam on pathway 1010. It is preferable that any clear optical components, such as lenses, used on top of the LEDs be of substantially the same refractive index as the liquid core, to reduce any reflective losses. The beam angle of the LEDs are designed such that the light exiting the LEDs remains substantially within the light guide by virtue of TIR. Wires to power and control the LEDs are required, but not shown. The LED illuminator assembly 1008 does not completely seal across the cross section of light guide 1006, but has some clearance or channel 1048 to communicate the liquid core 1004 with the gas expansion chamber 1002.

Any transparent liquid core 1004 might be used that meets TIR requirements and will not react unfavorably with the LED illuminator assembly 1008 or the dispersion particles 1012. In preferred embodiments, the liquid core 1004 is primarily mineral oil. The mineral oil conducts waste heat quite effectively, although in the case of extremely high-power illuminator assemblies care must be taken that the volume of the liquid core 1004 is sufficient for disposal of waste heat, or external cooling may be provided, for example, to prevent boiling of the liquid core.

In another embodiment, the LED illuminator assembly 1008 may include a permeable membrane 1050 that allows the liquid core 1004 to expand and contract as the temperature varies. In yet another embodiment, the numeral 1050 represents a sliding seal where the LED illuminator assembly 1008 and seal are of such dimension that when embedded in light guide 1006 a tolerance fit is achieved. Thus, none of the liquid core 1004 passes between the light guide 1006 and the LED illuminator assembly 1008, but thermal expansion or contraction of the liquid core 1004 is reflected by sliding of the LED illuminator assembly 1008 over the light guide 1006. Thus, the LED assembly 1008 rides as a piston and may, for example when end cap 1018 is removed, prevent evaporative losses of the liquid core 1004.

As shown, the optical source is LED illuminator assembly 1008, but other light sources may be used. For example, the LED illuminator assembly may include an incandescent light. Such lights are inexpensive and very bright.

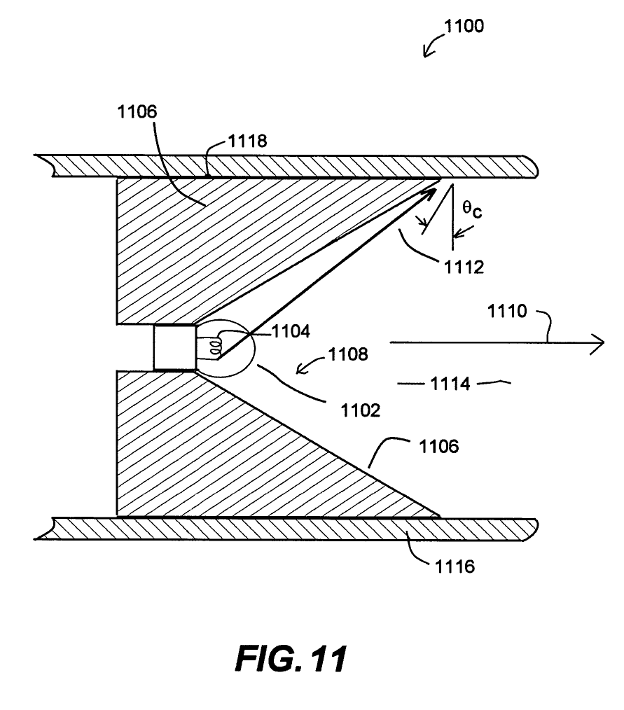

FIG. 11 shows an alternate illuminator assembly 1100 that uses an incandescent light bulb 1102 as its source. One problem with using incandescent lighting is that the light exiting bulb 1102 tends to radiate as from a filament 1104. Only a portion of the light radiates at angles that are suitable for TIR, so huge losses may occur. A reflection sleeve 1106 provides a conical cavity 1108. A reflective surface 1110 mitigates the optical losses by directing light on pathway 1108 at angles that are suitable for TIR. By ay of example, a ‘worst-case’ light ray 1112 exiting bulb 1102 is below the critical angle θ_{C} relative to the optical pathway. Preferably the reflection sleeve 1006 is made of metal that acts to dissipate waste heat into liquid core 1114. The reflective sleeve 1106 may be adhered to light guide 1116 or may ride as a piston with the provision of seal 1118.

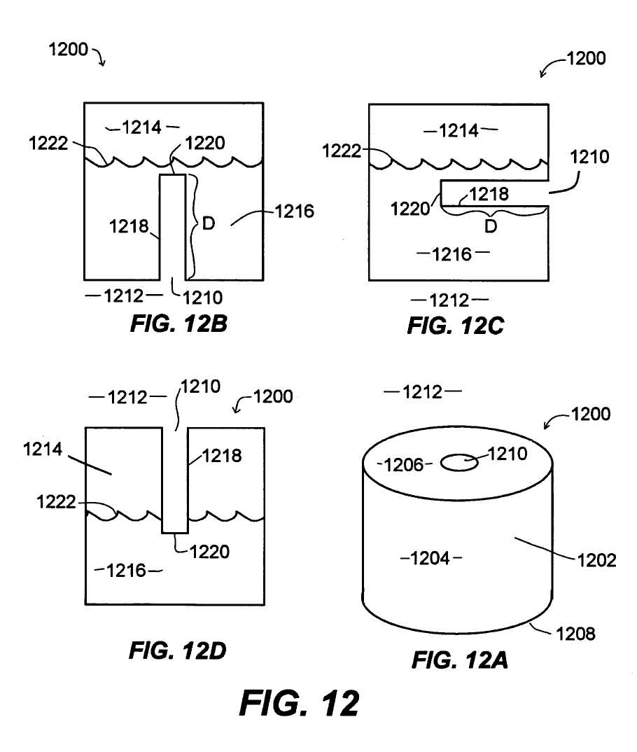

While the gas chamber 1002 shown in FIG. 10 requires a substantially vertical orientation to position the gas expansion chamber above the LED illumination assembly 1008. FIG. 12A is a perspective view of a gas expansion chamber 1200 that may be positioned within the light guide 1006 in any location and in any orientation. A cylindrical housing includes a tubular wall 1204 and opposed ends 1206, 1208. End 1206 contains a opening placing the interior of gas expansion chamber 1200 in fluidic communication with external liquid core 1212.

FIG. 12B is a midsectional view of the gas expansion chamber 1200 in a vertical orientation placing gas 1214 above interior liquid 1216. A tube 1218 extends into the internal liquid 1216 for a distance D to communicate opening 1210 with internal opening 1220. The tube 1218 provides the only path for egress and ingress of the liquid core 1212. It is preferred but optional that in this orientation the interface 1220 is above opening 1220. The volume of gas 1214 is preferably sized such that at minimum operating temperature, the opening 1220 remains below the interface 1222 (regardless of chamber orientation), and at maximum operating temperature the internal pressure in liquid core 1212 is still low enough to prevent disruption of system seals, for example, as shown in FIG. 10.

The only way a bubble may escape the expansion chamber into the light guide is if gas internal to the gas expansion chamber 1200 were to work up the tube 1218 when the gas expansion chamber 1200 is being reoriented, i.e., tilted at an angle. Therefore, it is preferable that the tube 1218 is of sufficiently diameter to provide capillary action with respect to the liquid core 1212, i.e.;, that the surface tension effects would diminish a likelihood that bubbles may flow up the tube 1218. A combination of material properties and dimensions allows these conditions to yield desired performance. For example, using a mineral-oil based liquid core of approximately 0.83 specific gravity and a tube of less than 0.8 mm internal diameter meets this goal. FIG. 12C shows these principles in operation when the gas expansion chamber 1200 is rotated 90° counterclockwise with respect to FIG. 12B. FIG. 12D shows these principles in operation when the gas expansion chamber 1200 is rotated 180° with respect to FIG. 12B.

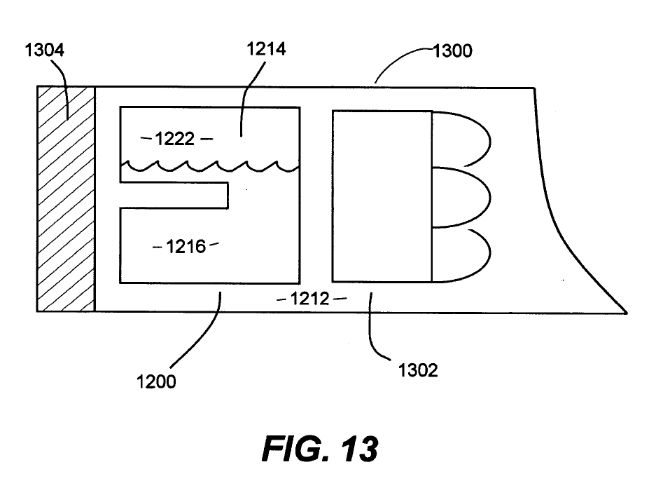

FIG. 13 shows the gas expansion chamber 1200 as it may be fitted within a light guide 1300 rearward of an LED assembly 1302. The light guide is sealed with end cap 1304.

This cylindrical version of an expansion chamber is simply one potential format of the principal of providing an expansion chamber internal to the light guide. It will be appreciated that alternate geometries may be utilized, such as chambers having ellipsoid, square, rhomboid, or octagonal cross-sections, or a plurality of interconnected chambers.

Some applications for the structures shown and described above extend, generally, to the replacement of neon or fluorescent lighting. Other applications extend to replacement of traditional fiber-optic lighting. By the selection of light source for emission characteristics and/or by filtering, the light may vary in color and intensity. Selection of emitters from an array of source emitters may, for example, permit dynamic switching of colors, and provide other color effects by commingling the emitted spectra. LEDs provide a great range of flexibility for color selection. A high-intensity LED produces a very narrow range of spectrum or color, for example, where the half-power spectrum width is typically 20 nm or less. One of the benefits of neon lighting is that it also has a narrow spectral range or width. In other words, neon lights put out light of a very specific color with very little unnecessary spectral output. By using LEDs of a certain color, a ‘neon-like’ light of a very specific color may be produced.

Since LEDs may be easily dimmed in a dynamic manner by reducing the current available to the LED, the light guides may be driven to produce a variable changing intensity of light. The LEDs have superior service life where this is frequently 100,000 hours or more.

Since a typical large (½″ ID) light guide system may hold multiple LEDs, by choosing, for example, half the LEDs to emit red and half to emit green, the light guide may be switched from red to green and back. This color switching is possible with any set of colors, given room in the light guide to accommodate the different LEDs.

Interesting “blending” of color effects may be created by putting a different color set of LEDs in illuminator assembly or in different LED illuminator assemblies 708, 714 as shown in FIG. 7. Simultaneous emission from LEDs that emit in different spectra results in a ‘blended’ color effect that can be changed dynamically by adjusting the brightness of emission.

Conventional color emission schema operate on the principle of three primary colors that may be combined in intensity to produce any humanly discernable color. These colors are red, green and blue (RGB), which may be represented LEDs of the illumination assemblies or illumination arrays. Programmable power electronics may drive these LEDs to emit in any combination of colors by the selection of LEDs for color and the application of current to the LEDs for intensity. Thus, the LED illuminator assemblies may be controlled to produce for the human eye virtually any color in the spectrum. Thus, a ‘neon-like’ and dispersed TIR lighting may provide color that is evenly distributed in intensity and dynamically controllable. The light ‘mixing’ is affected and enhanced by activity of the light dispersing agent in the core liquid described herein.

For downlighting applications, or any applications to replace conventional fiber optics where all incident light is radiated from the end, it has been found that a simple dispersion filter on the output properly blends together any remaining chromatic aberrations.

Some colors may be more efficiently created by dynamic blending of other than RGB LEDs. For example, a mixed set of near UV LEDs (395 nm center) and red LEDs (650 nm center) produces an intense light of “hot pink” color. In this way preferred colors may be optimized and produced efficiently from available LED colors by combining visible and non-visible spectra.

This concept is extended to providing lighting that meets spectral requirements outside the human visual range. For example, an application requiring a certain UV spectrum is created by mixing the light from multiple controllable UV LEDs of differing spectral output. Obviously this works as well for applications requiring specific IR spectrum as well.

In various aspects, the liquid core may provide efficient transfer of light of all practical spectra, operate effectively across a large temperature range, provide a good heat sink to the illuminator assemblies, be non-toxic and non-flammable, and be produced inexpensively. One preferred material for use as the majority component of the liquid core meeting these objectives is transparent mineral oil. Mineral oil is non-toxic and is considered non-flammable. Mineral oil has a high dielectric constant, so electronics may be placed in direct contact with the mineral oil without concern for current loss or shorting. The attenuation length of a material is defined as the transmission length of light in the medium such that the transmitted light is reduced by a factor of 1 db. Within the entire visible range, the attenuation length of transparent mineral oil is quite long, as opposed to aqueous solutions where the attenuation length of red light is particularly short. Mineral oil also has an excellent thermal conductivity, which makes it a good heat sink for the LED illuminator assemblies and other optical sources. Mineral oil is lighter than aqueous solutions, and this reduces the weight of light guide systems that contain mineral oil as the liquid core. Mineral oil has a suitably high refractive index, which is typically from 1.45 to 1.48, for use in TIR applications. Suitable mineral oils include, for example, Superla™5 by Amoco, Drakcol™7 by Pennreco, Duoprime™70 by Lyondell, and Scintillator™ fluid by Witco.

While fluids like mineral oil have these advantages, TIR is so efficient that in many embodiments a need arises to include a light dispersing agent in the liquid core. The light dispersing agent is provided in an amount that is suitable for the environment of use, such that the concentration of the light dispersing agent in the liquid core disperses light in a substantially uniform intensity as measured along the length of the light guide is required. Some diminution of intensity does occur along this length, but the effect is preferably not appreciable by the naked eye along a section of three feet, five feet, ten feet or more in length. 100911 A preferred form of light dispersing agent includes particles that are mixed to substantial homogeneity in the liquid, for example, as a suspension or a colloidal solution. By way of example, the particles may be rutile titanium dioxide. To prepare the liquid core rutile titanium dioxide particles of 0.15-0.6 microns in average diameter may be ground or milled thoroughly in a base of transparent mineral oil. Titanium dioxide has a refractive index near 2.72, and particles in this size range disperse light by scattering quite well to disrupt TIR. As the TiO₂ particles also have a high surface area per unit weight, a significant milling, agitation, stirring, or other work must be used to properly mix the particles into the mineral oil, and this may be done in successive stages of dilution. The use of a three-roll mill or pearl mill running under a vacuum is generally preferred. Improperly mixed particles tend to agglomerate and the agglomerants may deleteriously absorb light, rather than diffracting and scattering the light without loss. The agglomerants may also precipitate out of the scattering liquid colloidal suspension core to form a film of particles on the floor of the light guide. Accordingly, surfactants may be added to diminish the agglomeration phenomenon and as an aid in suspension. The surfactants may impair the optical performance of mineral oil, and so are used sparingly. The advantages of surfactant use may be balanced against the loss in optical performance for a particular intended use.

Other refracting particles may be used, including powdered diamond in the range of 0.1 to 0.9 microns. Any particle that meets the selection criteria of high refractive index and low absorption of the intended spectrum may be used, so long as the particle is sized such that it does not tend to settle in the liquid and remains indefinitely suspended in the liquid. This is also a function of viscosity, composition and specific gravity, which may change with thermal effects so environmental factors are also a consideration in liquid design. The term “liquid core” is hereby defined to include pure liquids and liquids that have suspensions of particles as described above, unless further description is provided to limit one option as opposed to the other.

The amount of scattering particles that are needed depends upon the length of light guide, the intended percent dispersion per unit length, and other factors. The amount may be determined empirically to assess the percentage of scattering particles per unit core fluid, although predictions may also be made according to Mie theory and deBeer's Law. By way of example, particle suspensions that are adequate for ‘neon-like’ dispersion in a 6 foot double-ended light guide may contain 0.0006% TiO2 by weight in mineral oil. Preferred concentrations include those from 0.1 ppm to 30 ppm TiO2 by weight, with higher or lower concentrations being amenable to atypical applications. While these particle suspensions generally meet visible spectrum needs, the same concept of empirical or theoretical justification may be utilized to extend the applications beyond the visible spectrum, such as into UV and IR wavelengths.

In addition, selection of particle materials and sizes may preferentially refract or absorb light of a selected color for non-TIR extraction, leaving the remaining light to pass to the end of the light guide. Thus, the scattering material may act as a filter. In such a manner, UV or IR light may be scattered from the core to eliminate unwanted spectra from end illumination as shown in FIG. 9. In particular, it is noted that TiO₂ particles of 15 nm to 50 nm in size tend to preferentially scatter and absorb UV-B UV-C light while not diffracting, reflecting or absorbing light of longer UV-A and visible wavelengths.

Small particles in a liquid core may solve another current problem in the liquid light guide art. Liquid filled light guides almost universally use expensive and hard-to-handle perfluoropolymers as cladding material within their light guides. This increases the cost, reduces the flexibility, reduces the efficiency and may causes other problems. As background, the refractive index of a liquid may be increased by adding into solution a material of higher refractive index. Examples of this are frequent in the art. This change in refractive index is in direct relationship with the combined material's compound refractive indexes. For example, a solution of 36 grams of common salt, NaCl, with 100 grams of water results in a solution with refractive index of about 1.38, which is almost a direct ratio of their weights and respective refractive indexes (1.33 for water, 1.53 for salt). This method for increasing the refractive index is limited to the solubility of the various materials that might be used.

The liquid core as described above provides a transparent or translucent high-index liquid that is composed of, most preferably, mineral oil with suspended rutile titanium dioxide crystals of an average particle diameter near 15 nm. The individual particles are sufficiently small and in such dilute concentrations that they do not cause visible light to be substantially diffracted, reflected or absorbed, but in combination they do favorably affect the refractive index for TIR. One emulsification of 18.7 grams TiO₂ with 100 grams mineral oil resulted in a clear liquid of 1.65 refractive index. This liquid can produce usable TIR when in combination with such cladding materials as polyethylene or polycarbonate, eliminating the need for perfluoropolymer and other expensive coatings.

The light guide systems disclosed herein are not limited to cylindrical pipes or tubes. Any volume that may support some level of TIR, even on a single surface as shown in surface 506 of FIG. 5, may use the scattering liquid colloidal suspension core to mix and scatter light. Flat panels may include, for example, as opposed window panes to create a viewing panel that glows in dynamically changing colors, but remains essentially transparent. Potential uses of such a panel, aside from decorative and privacy panels, include backlighting for LCD screens. Volumes like hollow beer glasses may be filled with scattering liquid colloidal suspension and lit with dynamically changing colors.

The colloidal particles may also be used in mineral gels, or liquids that have such high viscosity that the particles will remain either fixed in relatively position to one another, or will only drift slowly over a small range. This allows a new method for producing even distribution of light, wherein the mineral gel or high viscosity liquid with colloidal particles (preferably titanium dioxide or titanium dioxide particles with alumina coatings) fills tube 800 of FIG. 8, with the number of colloidal particles per unit volume varying with the distance from the illuminator assembly 708. In these instrumentalities, the number of colloidal particles per unit would vary, with fewer particles being nearer the illuminator assembly 708, such that the amount of light emitted 706 per unit length would be invariant, or would vary as specified for the application.

The use of colloidal particles in mineral gels could also provide many optical and lighting effects. These include the ability to create a double pane clear window or volume, filled with a transparent mineral gel that, along with the inner lining provide TIR effects within the window or volume. The entire gel could contain colloidal particles, and when illuminated would disperse light in angles beyond TIR and provide a glow in any color required. Alternatively, the gel could be partially emissive, with colloidal particles embedded, and partially purely transmissive, with no colloidal particles embedded. This instrumentality would allow a window with a glowing message within an otherwise clear volume.

A variety of potential applications may benefit from the instrumentalities disclosed above. The structures and methodologies herein described improve the art of injecting light into light guides and volumes, such that much higher luminosities are possible. These include the ability to produce light of virtual any visible color by the selection of LEDs. This may replace fluorescent lights that are designed for a specific spectrum, such as grow-lights, sunbed lamps, or lamps that provide sun-like illumination. Even white illumination that is provided by present fluorescent lights to replace the high power LED 100 may be improved by a system that runs on low voltage, require no wires in the light-emitting device itself, has much longer life, and is flexible, durable, and non-shatterable.

Other applications include a battery powered replacement for present chemical light sticks, improved by having an on/off switch, not requiring disposal after a single night, and being able to produce dramatic dynamic color effects impossible with present chemical light sticks.

Signage may be improved to replace neon signage that is portable, large enough for billboards, small enough for table top displays, and changeable on a frequent basis, such as special sale or event signs. Neon-like signs may be put on the side of buses, cars and trucks. The ability to choose specific colors could allow the production of ‘neon-like’ signs that exactly match a company's logo colors.

Other applications include children's safety equipment, such as lighted bike helmets, lighted bike frames, and more. Flexible, virtually shadowless lights can be made for auto mechanics and other applications. Given the low voltage requirements, the present instrumentalities provide for liquid light guides that are ideal for RV and boat lighting, including boat port/starboard and mast lighting. Being safe, non-toxic, low voltage and waterproof makes the present light guides well-suited for swimming pool and hot tub lighting. Another application includes solar powered outdoor trim lighting. Additional adaptations include interior baseboard lighting trim and interior mood lighting, which allows mood-lighting of a room in any practical color and intensity. Home holiday ‘neon-like, decoration another application, including alternatives to Christmas lighting that are less likely to ignite a Christmas tree. Personal signs for use inside of car windows may be made. Fisherman that presently use small chemical light sticks for lures may now use battery-powered systems that are shaped like a bait fish that glows with any fish-attracting color that may be desired. For children, there may be provided neon necklaces and bangles, clothing trim and accents, and various use in toys. The present instrumentalities may be used on fair and carnival rides, and trim for buildings that are large or small. In addition, floor safety lighting such as used in airplanes and movie theatres to light the way to exits during fires or emergencies, is another potential application.

The present invention in its broader aspects is not limited to the specific embodiments shown herein and described. Those skilled in the art may appreciate that various insubstantial changes and modifications may be made to the disclosed embodiments without departing from the scope of the invention as described herein. The inventors hereby state their intent to rely upon the Doctrine of Equivalents to protect the invention.

1. In a light guide system that operates on the principle of total internal reflectance (TIR) between a core and a cladding along an optical pathway, the improvement comprising:
the cladding being translucent;
the core being liquid; and
a light dispersing agent distributed in the core to provide a substantially even disruption of TIR along the optical pathway such that disrupted light passes through the cladding.

2. The light guide system of claim 1, wherein the liquid has a majority component of mineral oil.

3. The light guide system of claim 1, wherein the light dispersing agent is selected from the group consisting of titanium dioxide and alumina.

4. The light guide system of claim 1, wherein the light dispersing agent comprises titanium dioxide.

5. The light guide system of claim 1, wherein the light dispersing agent is comprised of particles in the range of 0.1 to 1 micron.

6. The light guide system of claim 1, wherein the dispersing agent is a colloidal suspension within the core.

7. The light guide system of claim 1, configured and arranged as a promotional sign.

8. The light guide system of claim 1, constructed and arranged as a channel letter.

9. The light guide system of claim 1, constructed and arranged as a flexible. liquid filled tube.

10. The light guide system of claim 1, wherein the translucent optical guide comprises flat panels.

11. The light guide system of claim 1, constructed and arranged as an item selected from the group consisting of safety lights, automotive lights, recreational lights, boat lights, swimming pool lights, boat mast lights, and hot tub lights.

12. The light guide system of claim 1, constructed and arranged as an item selected from the group consisting of solar powered outdoor trim lights, interior baseboard lights, building trim lights, interior mood lights, home holiday lights, and personal signs.

13. The light guide system of claim 1, constructed and arranged as an item selected from the group consisting of necklaces, bangles, clothing trim, a clothing accent, and a toy.

14. The light guide system of claim 1, constructed and arranged as a carnival ride light.

15. The light guide system of claim 1, constructed and arranged as an item selected from the group consisting of a lighted bike helmets and a lighted bike frame.

16. The light guide system of claim 1, wherein the light source is immersed in the core.

17. In a light guide system that operates on the principle of total internal reflectance (TIR) between a core and a cladding along an optical pathway, the improvement comprising:
the cladding being translucent;
the core being gel; and
a light dispersing agent distributed in the core to provide a disruption of TIR along the optical pathway such that disrupted light passes through the cladding.

18. The light guide system of claim 17, wherein the gel has a majority component of mineral oil.

19. The light guide system of claim 17, wherein the light dispersing agent is selected from the group consisting of titanium dioxide and alumina.

20. The light guide system of claim 17, wherein the light dispersing agent comprises titanium dioxide.

21. The light guide system of claim 17, wherein the light dispersing agent is comprised of particles in the range of 0.1 to 10 microns

22. The light guide system of claim 17, wherein the dispersing agent is a colloidal suspension within the core.

23. The light guide system of claim 17, configured and arranged as a promotional sign.

24. The light guide system of claim 17, constructed and arranged as a channel letter.

25. The light guide system of claim 17, constructed and arranged as a flexible. liquid filled tube.

26. The light guide system of claim 17, wherein the translucent optical guide comprises flat panels.

27. The light guide system of claim 17, constructed and arranged as an item selected from the group consisting of safety lights, automotive lights, recreational lights, boat lights, swimming pool lights, boat mast lights, and hot tub lights.

28. The light guide system of claim 17, constructed and arranged as an item selected from the group consisting of solar powered outdoor accent lights, interior baseboard lights, building trim lights, interior mood lights, home holiday lights, and personal signs.

29. The light guide system of claim 17, constructed and arranged as an item selected from the group consisting of necklaces, bangles, clothing trim, a clothing accent, and a toy.

30. The light guide system of claim 17, constructed and arranged as a carnival ride light.

31. The light guide system of claim 17, constructed and arranged as an item selected from the group consisting of a lighted bike helmets and a lighted bike frame.

32. The light guide system of claim 17, wherein the light source is immersed in the core.

33. The light guide system of claim 17, wherein the concentration of the light dispersing agent is varied along the optical pathway to correspondingly vary the disruption of TIR along the optical pathway.

34. The light guide system of claim 33, wherein the concentration of light dispersing agent is varied along the optical pathway wherein the proportional distribution provides even distribution of light through the cladding along the entire waveguide.

35. The light guide system of claim 33, wherein the concentration of light dispersing agent is varied to create illuminated objects within the light guide.

36. The light guide system of claim 35, wherein the object is three dimensional.

37. The light guide system of claim 33, wherein the light source is immersed in the core.

38. In a light guide system that operates on a combination of the principle of total internal reflectance (TIR) between a core and a cladding, and normal optical reflection along an optical pathway, the improvement comprising:
the cladding being translucent;
the core being one of a gel and a liquid; and
a light dispersing agent distributed in the core to provide a disruption of TIR along the optical pathway, or disruption in reflected light, such that disrupted light passes through the cladding.

39. The light guide system of claim 38, wherein the core has a majority component of mineral oil.

40. The light guide system of claim 38, wherein the light dispersing agent is selected from the group consisting of titanium dioxide and alumina.

41. The light guide system of claim 38, wherein the light dispersing agent comprises titanium dioxide.

42. The light guide system of claim 38, wherein the light dispersing agent is comprised of particles in the range of 0.1 to 10 microns

43. The light guide system of claim 38, wherein the dispersing agent is a colloidal suspension within the core.

44. The light guide system of claim 38, constructed and arranged as a promotional sign.

45. The light guide system of claim 38, constructed and arranged as a channel letter.

46. The light guide system of claim 38, constructed and arranged as a flexible. filled tube.

47. The light guide system of claim 38, wherein the translucent optical guide comprises flat panels.

48. The light guide system of claim 38, wherein the light source is immersed in the core.

49. The light guide system of claim 38, wherein the concentration of the light dispersing agent is varied along the optical pathway to correspondingly vary the disruption of TIR along the optical pathway.

50. The light guide system of claim 49, wherein the concentration of light dispersing agent varies along the optical pathway such that the proportional distribution provides even distribution of light through the cladding along the entire waveguide.

51. The light guide system of claim 49, wherein the concentration of light dispersing agent is varied to create illuminated objects within the light guide.

52. The light guide system claim 51, wherein the object is a three dimensional object.

53. The light guide system of claim 49, wherein the light source is immersed in the core.

54. A core with a first index of refraction for use in a light guide system that operates on the principle of total internal reflectance (TIR) between a core and a cladding along an optical pathway, the improvement comprising:
the core including a colloidal suspension of suboptical particles of high refractive index in a substantially clear liquid or gel, the particles having an increased second index of refraction.

55. The core liquid of claim 54, wherein the suboptical particles comprise titanium dioxide.

56. The core liquid of claim 54, wherein the suboptical particles are of a size ranging from 5 nM to 100 nM.

57. An LED assembly for illumination of a light guide comprising:
an LED die supported by a substrate;
electrical contacts configured to provide power for activation of the LED die to emit light;
a reflector bonded to the substrate and operable to direct light from the LED die along an optical pathway when the LED die is activated for emission of the light.

58. The LED assembly of claim 57, wherein the reflector has a frustoconical shape.

59. The method of claim 57, wherein the light source simultaneously emits multiple wavelengths.

60. The method of claim 57, wherein the multiple wavelengths are within the visible color spectrum.

61. An LED assembly for heat sinking of excess heat from an LED assembly for illumination of a light guide comprising:
an LED die supported by a substrate; and
electrical contacts configured to provide power for activation of the LED die to emit light;
wherein the LED assembly is immersed in the light guide core.

62. The LED assembly of claim 61, wherein there is a reflector thermally bonded to the substrate and operable to direct light from the LED die along an optical pathway when the LED die is activated for emission of the light, the reflector being operable to communicate waste heat into the core.

63. The LED assembly of claim 61, wherein the LED die is in direct contact with the core to communicate waste heat directly into the core.

64. The method of claim 61, wherein the light source simultaneously emits multiple wavelengths.

65. The method of claim 61, wherein the multiple wavelengths are within the visible color spectrum.

66. A method of compensating for expansion and contraction of a core in a liquid or gel core light guide system comprising:
illuminating the core on an optical pathway that extends forward from one or more sources embedded within the core; and
compensating for core expansion from behind the illumination source, thereby preventing disruption of the optical path.

67. The method of claim 66, wherein the step of illuminating occurs in an unsealed light guide.

68. The method of claim 66, wherein the step of illuminating occurs in a sealed light guide, and further comprising a step of compensating for pressure changes inside the light guide from a position behind the illumination source.

69. The method of claim 68, wherein the step of compensating includes reorienting the light guide form one position to another by rotational movement without producing bubbles that move into the optical path of the light guide.

70. A light-guide system comprising:
a core made of at least one of a liquid and a gel;
an illumination source embedded into the core; and
means for compensating expansion and contraction of the core from a position behind the illumination source, such that there is no disruption of the optical path by the compensating means.

71. A light guide system comprising:
a core made of at least one of a liquid and a gel;
an illumination source embedded into the core; and
a light dispersing agent distributed in the core to provide a disruption of TIR along the optical pathway such that disrupted light passes through the cladding.

72. A light guide system comprising:
a liquid or gel core;
an illumination source embedded into the core;
wherein the illumination source is cooled directly by contact with the core.

73. The light guide system of claim 72, where there is a reflector thermally bonded or manufactured as part of the substrate and operable to direct light from the LED die along an optical pathway when the LED die is activated for emission of the light, where the reflector radiates waste heat into the core.

74. The LED assembly of claim 72, wherein the LED die is in direct contact with the core to communicate waste heat directly into the core.

75. A light guide system comprising:
a core made of at least one of a liquid and a gel;
an illumination source embedded into the core and positioned to project light forward onto an optical pathway; and
a compensator for expansion and contraction of the core of the light guide.

76. A light guide system comprising:
a core made of at least one of a liquid and a gel;
an illumination source embedded into the core positioned to project light forward onto an optical pathway;
wherein the illumination source is cooled directly by contact with the core; and
a compensator for expansion and contraction of the core from a position behind the illumination source.

77. A light guide system comprising:
a core made of at least one of a liquid and a gel;
an illumination source embedded into the core and positioned to project light forward onto an optical pathway;
a light dispersing agent distributed in the core to provide a disruption of TIR along the optical pathway such that disrupted light passes through the cladding; and
a compensator for expansion and contraction of the core of the light guide system from a position behind the illumination source.

78. The LED assembly of claim 61, wherein there is a reflector connected o the substrate and operable to direct light from the LED die along the optical pathway when the LED die is activated for emission of the light, the reflector being operable to communicate waste heat into the core.
